(19) United States
(12) Patent Application Publication
(10) Pub. No.: US 2023/0214125 A1
(43) Pub. Date: Jul. 6, 2023

(54) Data Storage Device With Physical Health Indication

(71) Applicant: Western Digital Technologies, Inc., San Jose, CA (US)

(72) Inventors: David AVRAHAM, Even Yehuda (IL); Alexander BAZARSKY, Holon (IL); Ran ZAMIR, Ramat Gan (IL); Hadar TAGAR, Kfar Saba (IL)

(21) Appl. No.: 17/569,360

(22) Filed: Jan. 5, 2022

(51) Int. Cl. G06F 3/06

(52) U.S. Cl. CPC G06F 3/0616; G06F 3/0653; G06F 3/0673

(57) ABSTRACT

A data storage device includes a housing and an indicator coupled to the housing. The indicator is configured to indicate a health and/or life stage of the data storage device and operate in the absence of an external power source. The indicator is an electrophoretic display or includes a thermochromic material. The electrophoretic display includes a single indication. The electrophoretic display is a scaling bar. The indicator is coupled to a controller. The controller is configured to calculate a health parameter of the data storage device, determine that that the health parameter has exceeded a threshold, and cause the indicator change from a first state to a second state.

### BACKGROUND OF THE DISCLOSURE

### Field of the Disclosure

Embodiments of the present disclosure generally relate to data storage devices, such as solid state drives (SSDs) and hard disk drives (HDDs), and, more specifically, physical health indications for the data storage devices.

### Description of the Related Art

The amount of data being stored in data storage devices have increased over time. Likewise, the capacity of the data storage device has increased over time. With the increasing capacity of the data storage device, the reliability of the data storage device, especially maintaining data integrity, is crucial. For the reliability of the data storage systems, customers typically rely on the warranties provided by the manufacturers of the data storage devices that specify certain performance metrics and a lifetime of the data storage system.

A health of data storage device may be quantified by different measurements. For example, the health may be quantified by one or more of a bit error rate (BER), a write amplification factor (WAF), a program erase cycle (PEC) count, and a time of usage of a memory device of the data storage device. Over a period of usage, the health of the data storage device decreases. When a customer purchases a new data storage device (i.e., a data storage device that has not been used previously, outside of manufacturing quality assurance), the customer assumes that the data storage device has beginning of life conditions (e.g., the best performance). However, customers may instead be provided with a data storage device that has been previously used (i.e., has reduced performance), but returned to the manufacturer under the assumption that the data storage device has not been used. Thus, providing customers with a used data storage device instead of a new data storage device may decrease the reputation of the company providing the data storage device.

Therefore, there is a need in the art for ensuring reliability of a new data storage device.

### SUMMARY OF THE DISCLOSURE

The present disclosure generally relates to data storage devices, such as solid state drives (SSDs) and hard disk drives (HDDs), and, more specifically, physical health indications for the data storage devices. A data storage device includes a housing and an indicator coupled to the housing. The indicator is configured to indicate a health and/or life stage of the data storage device and operate in the absence of an external power source. The indicator is an electrophoretic display or includes a thermochromic material. The electrophoretic display includes a single indication. The electrophoretic display is a scaling bar. The indicator is coupled to a controller. The controller is configured to calculate a health parameter of the data storage device, determine that that the health parameter has exceeded a threshold, and cause the indicator change from a first state to a second state.

In one embodiment, a data storage device includes a housing and an indicator coupled to the housing. The indicator is configured to indicate a health and/or life stage of the data storage device and operate in the absence of an external power source.

In another embodiment, a data storage device includes a housing, a controller disposed in the housing, and an indicator coupled to the housing and the controller. The controller is configured to calculate a health parameter of the data storage device, determine that that the health parameter has exceeded a threshold, and cause the indicator change from a first state to a second state.

In another embodiment, a data storage device includes means to indicate a use and/or a health of the data storage device absent of an external power source.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic block diagram illustrating a storage system in which a data storage device may function as a storage device for a host device, according to certain embodiments.

FIGS. 2A and 2B are exemplary illustrations of a housing of a data storage device having an indicator, according to certain embodiments.

FIGS. 3A and 3B are exemplary illustrations of an electrophoretic display in a light state and a dark state, according to certain embodiments.

FIG. 4 is an exemplary illustration of an indicator having a single indication, according to certain embodiments.

FIG. 5 is an exemplary illustration of an indicator having a scaling bar, according to certain embodiments.

FIG. 6 is an exemplary illustration of an indicator having a single indication, according to certain embodiments.

FIG. 7 is a flow diagram illustrating a method of a data storage device using an indicator as an indication of a health of the data storage device, according to certain embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In the following, reference is made to embodiments of the disclosure. However, it should be understood that the disclosure is not limited to specifically described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments, and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

The present disclosure generally relates to data storage devices, such as solid state drives (SSDs) and hard disk drives (HDDs), and, more specifically, physical health indications for the data storage devices. A data storage device includes a housing and an indicator coupled to the housing. The indicator is configured to indicate a health and/or life stage of the data storage device and operate in the absence of an external power source. The indicator is an electrophoretic display or includes a thermochromic material. The electrophoretic display includes a single indication. The electrophoretic display is a scaling bar. The indicator is coupled to a controller. The controller is configured to calculate a health parameter of the data storage device, determine that that the health parameter has exceeded a threshold, and cause the indicator change from a first state to a second state.

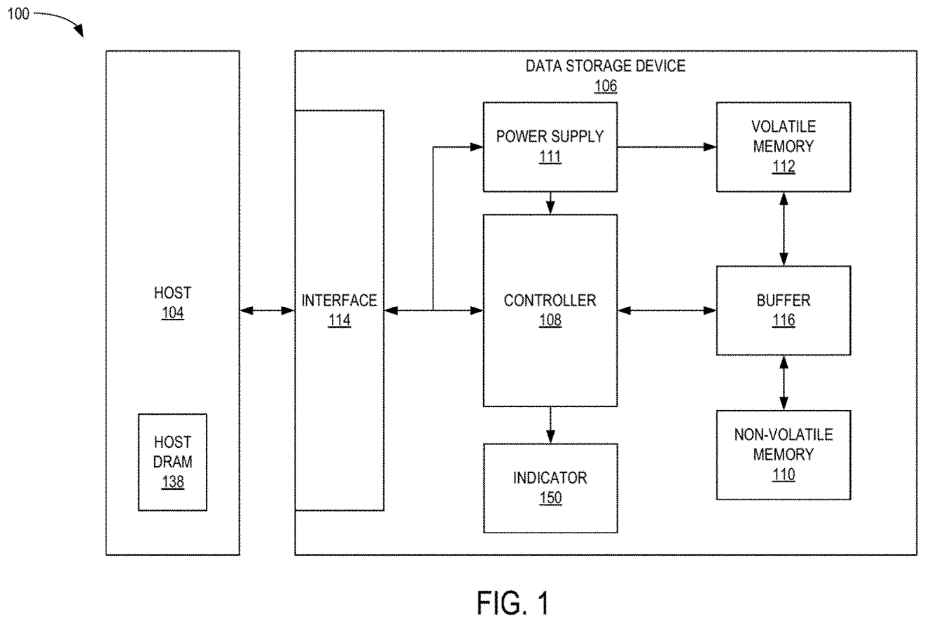

FIG. 1 is a schematic block diagram illustrating a storage system 100 in which a host device 104 is in communication with a data storage device 106, according to certain embodiments. For instance, the host device 104 may utilize a non-volatile memory (NVM) 110 included in data storage device 106 to store and retrieve data. The host device 104 comprises a host DRAM 138. In some examples, the storage system 100 may include a plurality of storage devices, such as the data storage device 106, which may operate as a storage array. For instance, the storage system 100 may include a plurality of data storage devices 106 configured as a redundant array of inexpensive/independent disks (RAID) that collectively function as a mass storage device for the host device 104.

The host device 104 may store and/or retrieve data to and/or from one or more storage devices, such as the data storage device 106. As illustrated in FIG. 1, the host device 104 may communicate with the data storage device 106 via an interface 114. The host device 104 may comprise any of a wide range of devices, including computer servers, network-attached storage (NAS) units, desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or other devices capable of sending or receiving data from a data storage device.

The data storage device 106 includes a controller 108, NVM 110, a power supply 111, volatile memory 112, the interface 114, and a write buffer 116. In some examples, the data storage device 106 may include additional components not shown in FIG. 1 for the sake of clarity. For example, the data storage device 106 may include a printed circuit board (PCB) to which components of the data storage device 106 are mechanically attached and which includes electrically conductive traces that electrically interconnect components of the data storage device 106 or the like. In some examples, the physical dimensions and connector configurations of the data storage device 106 may conform to one or more standard form factors. Some example standard form factors include, but are not limited to, 3.5″ data storage device (e.g., an HDD or SSD), 2.5″ data storage device, 1.8″ data storage device, peripheral component interconnect (PCI), PCI-extended (PCI-X), PCI Express (PCIe) (e.g., PCIe x1, x4, x8, x16, PCIe Mini Card, MiniPCI, etc.). In some examples, the data storage device 106 may be directly coupled (e.g., directly soldered or plugged into a connector) to a motherboard of the host device 104.

Interface 114 may include one or both of a data bus for exchanging data with the host device 104 and a control bus for exchanging commands with the host device 104. Interface 114 may operate in accordance with any suitable protocol. For example, the interface 114 may operate in accordance with one or more of the following protocols: advanced technology attachment (ATA) (e.g., serial-ATA (SATA) and parallel-ATA (PATA)), Fibre Channel Protocol (FCP), small computer system interface (SCSI), serially attached SCSI (SAS), PCI, and PCIe, non-volatile memory express (NVMe), OpenCAPI, GenZ, Cache Coherent Interface Accelerator (CCIX), Open Channel SSD (OCSSD), or the like. Interface 114 (e.g., the data bus, the control bus, or both) is electrically connected to the controller 108, providing an electrical connection between the host device 104 and the controller 108, allowing data to be exchanged between the host device 104 and the controller 108. In some examples, the electrical connection of interface 114 may also permit the data storage device 106 to receive power from the host device 104. For example, as illustrated in FIG. 1, the power supply 111 may receive power from the host device 104 via interface 114.

The NVM 110 may include a plurality of memory devices or memory units. NVM 110 may be configured to store and/or retrieve data. For instance, a memory unit of NVM 110 may receive data and a message from controller 108 that instructs the memory unit to store the data. Similarly, the memory unit may receive a message from controller 108 that instructs the memory unit to retrieve data. In some examples, each of the memory units may be referred to as a die. In some examples, the NVM 110 may include a plurality of dies (i.e., a plurality of memory units). In some examples, each memory unit may be configured to store relatively large amounts of data (e.g., 128 MB, 256 MB, 512 MB, 1 GB, 2 GB, 4 GB, 8 GB, 16 GB, 32 GB, 64 GB, 128 GB, 256 GB, 512 GB, 1 TB, etc.).

In some examples, each memory unit may include any type of non-volatile memory devices, such as flash memory devices, phase-change memory (PCM) devices, resistive random-access memory (ReRAM) devices, magneto-resistive random-access memory (MRAM) devices, ferroelectric random-access memory (F-RAM), holographic memory devices, and any other type of non-volatile memory devices.

The NVM 110 may comprise a plurality of flash memory devices or memory units. NVM Flash memory devices may include NAND or NOR-based flash memory devices and may store data based on a charge contained in a floating gate of a transistor for each flash memory cell. In NVM flash memory devices, the flash memory device may be divided into a plurality of dies, where each die of the plurality of dies includes a plurality of physical or logical blocks, which may be further divided into a plurality of pages. Each block of the plurality of blocks within a particular memory device may include a plurality of NVM cells. Rows of NVM cells may be electrically connected using a word line to define a page of a plurality of pages. Respective cells in each of the plurality of pages may be electrically connected to respective bit lines. Furthermore, NVM flash memory devices may be 2D or 3D devices and may be single level cell (SLC), multi-level cell (MLC), triple level cell (TLC), or quad level cell (QLC). The controller 108 may write data to and read data from NVM flash memory devices at the page level and erase data from NVM flash memory devices at the block level.

The power supply 111 may provide power to one or more components of the data storage device 106. When operating in a standard mode, the power supply 111 may provide power to one or more components using power provided by an external device, such as the host device 104. For instance, the power supply 111 may provide power to the one or more components using power received from the host device 104 via interface 114. In some examples, the power supply 111 may include one or more power storage components configured to provide power to the one or more components when operating in a shutdown mode, such as where power ceases to be received from the external device. In this way, the power supply 111 may function as an onboard backup power source. Some examples of the one or more power storage components include, but are not limited to, capacitors, super-capacitors, batteries, and the like. In some examples, the amount of power that may be stored by the one or more power storage components may be a function of the cost and/or the size (e.g., area/volume) of the one or more power storage components. In other words, as the amount of power stored by the one or more power storage components increases, the cost and/or the size of the one or more power storage components also increases.

The volatile memory 112 may be used by controller 108 to store information. Volatile memory 112 may include one or more volatile memory devices. In some examples, controller 108 may use volatile memory 112 as a cache. For instance, controller 108 may store cached information in volatile memory 112 until the cached information is written to the NVM 110. As illustrated in FIG. 1, volatile memory 112 may consume power received from the power supply 111. Examples of volatile memory 112 include, but are not limited to, random-access memory (RAM), dynamic random access memory (DRAM), static RAM (SRAM), and synchronous dynamic RAM (SDRAM (e.g., DDR1, DDR2, DDR3, DDR3L, LPDDR3, DDR4, LPDDR4, and the like)).

Controller 108 may manage one or more operations of the data storage device 106. For instance, controller 108 may manage the reading of data from and/or the writing of data to the NVM 110. In some embodiments, when the data storage device 106 receives a write command from the host device 104, the controller 108 may initiate a data storage command to store data to the NVM 110 and monitor the progress of the data storage command. Controller 108 may determine at least one operational characteristic of the storage system 100 and store at least one operational characteristic in the NVM 110. In some embodiments, when the data storage device 106 receives a write command from the host device 104, the controller 108 temporarily stores the data associated with the write command in the internal memory or write buffer 116 before sending the data to the NVM 110.

The data storage device 106 further includes an indicator 150 coupled to the controller 108. The indicator 150 may be an indicator unit, such that that the indicator unit includes the indicator 150 and a heat sink or a transistor. The heat sink may work in a passive manner by using heat generated by the data storage device to create an indication and the data storage device may actively heat the indicator using a heat source, such as the transistor, to create an indication. It is to be understood that the previously listed options are not intended to be limiting, but to provide an example of possible embodiments. The indicator 150 may operate in absence of an external power source. For example, the indicator 150 may be a thermochromic material or an electrophoretic display.

Furthermore, the indication may be based on one or more of a PEC count, an aggregation of a PEC count across one or more blocks, power on hours, bad block count, and breach of temperature ranges supported by the data storage device 106. The aggregation of a PEC count may be calculated using a mean, a minimum, and/or a maximum PEC count of one or more memory devices of the NVM 110. Additionally, the controller 108 may include logic to cause the indicator 150 to start operating after the data storage device 106 exceeds a certain number of testing cycles or a certain period of time. The certain number of testing cycles or the certain period of time may be an average number of testing cycles or average period of time that the data storage device 106 is in use due to testing as part of a manufacturing process prior to customer usage. In the description herein, the original state of the indication may be a first state and a changed or adjusted state of the indication may be a second state. The second state may be a permanent state, such that the indication cannot be changed back to the first state.

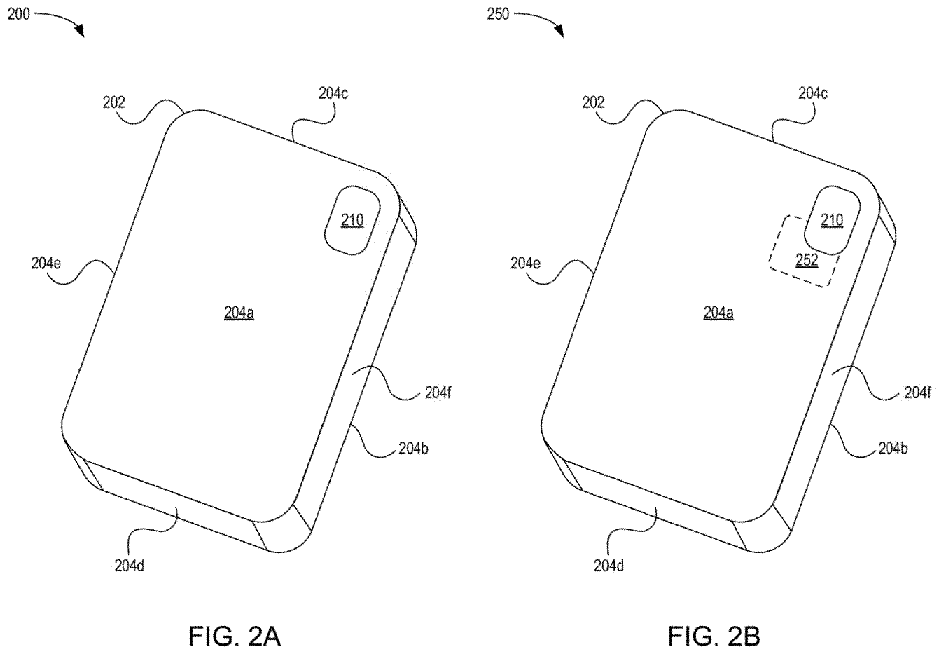

FIGS. 2A and 2B are exemplary illustrations of a housing 202 of a data storage device 200, 250, which may be the data storage device 106 of FIG. 1, having an indicator 210, which may be the indicator 150 of FIG. 1, according to certain embodiments. For simplification, FIGS. 2A and 2B are described together herein.

The housing 202 has a first side 204a, a second side 204b, a third side 204c, a fourth side 204d, a fifth side 204e, and a sixth side 204f. The first side 204a is parallel to the second side 204b, where the first side 204a and the second side 204b are perpendicular to the third side 204c, the fourth side 204d, the fifth side 204e, and the sixth side 204f. In some examples, the first side 204a may be a front side and the second side may be a back side. The third side 204c is perpendicular to the fifth side 204e and the sixth side 204f and parallel to the fourth side 204d. The fourth side 204d is perpendicular to the fifth side 204e and the sixth side 204f. The fifth side 204e and the sixth side 204f are parallel to each other. The first side 204a and the second side 204b may be dimensionally substantially similar, the third side 204c and the fourth side 204d may be dimensionally substantially similar, and the fifth side 204e and the sixth side 204f may be dimensionally substantially similar.

The first side 204a includes the indicator 210. It is to be understood that the indicator 210 location shown is for illustrative purposes and the indicator 210 may be located in a different location on the first side 204a or on any of the other sides (e.g., the second size 204b, the third side 204c, the fourth side 204d, the fifth side 204e, and the sixth side 204f). Furthermore, it is contemplated that the data storage device 200, 250 may have more than one indicator 210. The indicator 210 may be either a electrophoretic display or a thermochromic material. Referring to FIG. 2B, when the indicator 210 is a thermochromic material, the indicator 210 is coupled to a heat source 252 disposed in the housing 202. The heat source 252 may be either a resistor, such that the data storage device 250 may actively heat the thermochromic material using the resistor, or a heat sink, such that heat generated by the data storage device 250 passively heats the heat sink which heats the thermochromic material.

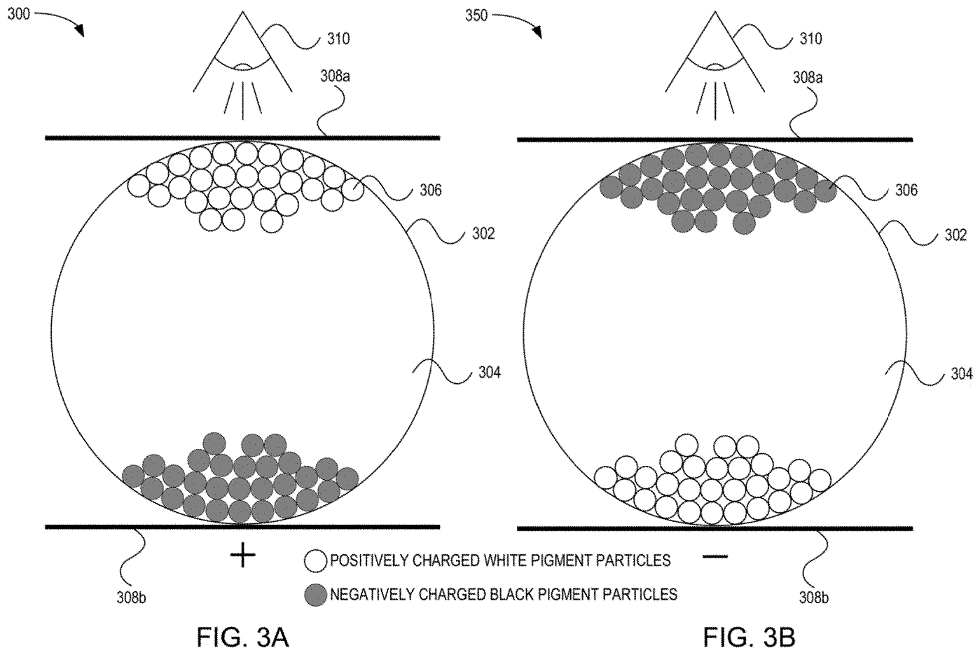

FIGS. 3A and 3B are exemplary illustrations of an electrophoretic display 300, 350 in a light state and a dark state, according to certain embodiments. The electrophoretic display 300, 350 may be the indicator 210 of FIGS. 2A and 2B. An eye 310 represents a viewing side of the electrophoretic display 300, 350. The electrophoretic display 300, 350 includes a capsule 302 that includes a suspension fluid 304 and a plurality of pigment particles 306, where the plurality of pigment particles 306 is suspended in the suspension fluid 304. The plurality of pigment particles 306 includes positively charged white pigment particles and negatively charged black pigment particles. The electrophoretic display 300, 350 also includes a top transparent electrode 308a and a bottom electrode 308b, where the bottom electrode 308b is opposite of the viewing side and the top transparent electrode 308a is adjacent to the viewing side. The bottom electrode 308b may induce either a positive charge or a negative charge.

As shown in FIG. 3A, when a positive charge is induced at the bottom electrode 308b, the positively charged white pigment particles of the plurality of pigment particles 306 migrates away (are repelled) from the bottom electrode 308b and the negatively charged black pigment particles of the plurality of pigment particles 306 migrates towards (are attracted to) the bottom electrode 308b. As shown in FIG. 3B, when a negative charge is induced at the bottom electrode 308b, the positively charged white pigment particles of the plurality of pigment particles 306 migrates towards (are attracted to) the bottom electrode 308b and the negatively charged black pigment particles of the plurality of pigment particles 306 migrates away (are repelled) from the bottom electrode 308b.

Furthermore, the attraction/repulsion of the pigment particles may be permanent until another charge is induced at the bottom electrode 308b. In other words, when a charge is induced at the bottom electrode 308b, the positively charged white pigment particles and the negatively charged black pigment particles of the plurality of pigment particles 306 is either attracted to or repelled from the bottom electrode 308b. It is to be understood that the induced charge may not be constant. In other words, the display only consumes power when a change occurs in the screen. When the positively charged white pigment particles are near the top transparent electrode 308a, the display appears light to the eye 310. However, when the negatively charged black pigment particles are near the top transparent electrode 308a, the display appears dark to the eye 310.

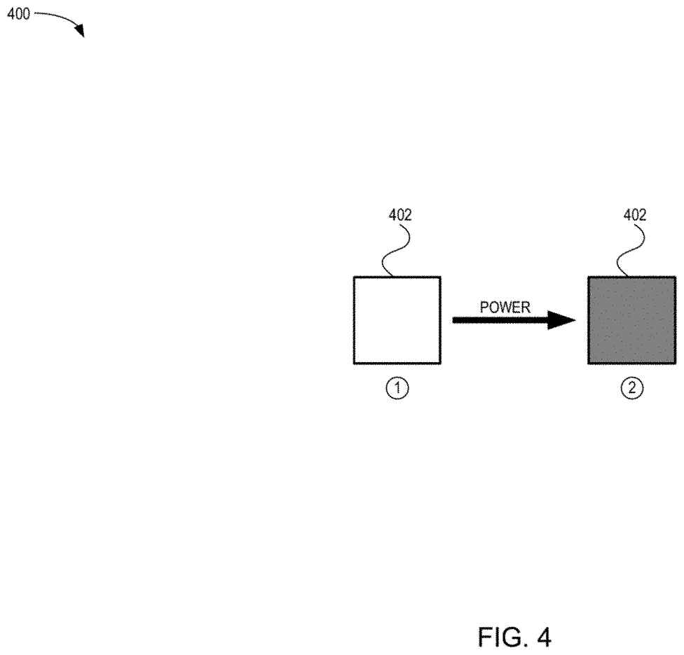

FIG. 4 is an exemplary illustration of an indicator 400 having a single indication 402, according to certain embodiments. The indicator 400 may be the indicator 150 of the data storage device 106 of FIG. 1 and/or the indicator 210 of FIGS. 2A and 2B. In some examples, the indicator 400 may be the electrophoretic display 300, 350 of FIGS. 3A and 3B. At “1”, the indicator 400 is shown as white or light to indicate that a data storage device, such as the data storage device 106 of FIG. 1, associated with the indicator 400 has not been connected to power. At “2”, the indicator 400 is shown as black or dark to indicate that the data storage device 106 has been connected to power. It is contemplated that a controller, such as the controller 108 of FIG. 1, may determine that a period of time has elapsed before changing the indication 402 from light to dark.

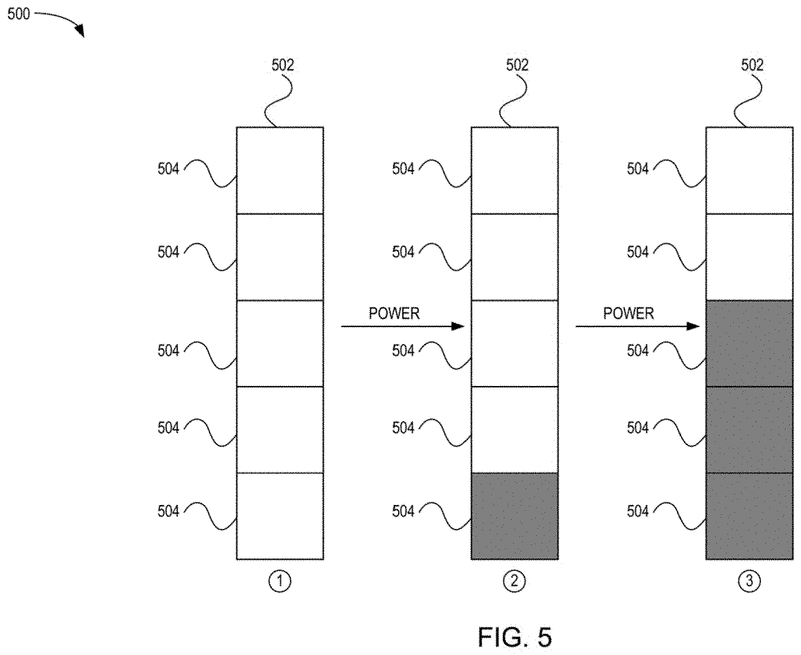

FIG. 5 is an exemplary illustration of an indicator 500 having a scaling bar 502, according to certain embodiments. The scaling bar 502 includes a plurality of indications 504. The number of indications of the plurality of indications is not intended to be limiting. Each indication of the plurality of indications 504 may be the indicator 150 of the data storage device 106 of FIG. 1 and/or the indicator 210 of FIGS. 2A and 2B. In some examples, each indication of the plurality of indications 504 may be the electrophoretic display 300, 350 of FIGS. 3A and 3B. The scaling bar 502 may be based on one or more of a PEC count, an aggregation of a PEC count across one or more blocks, power on hours, bad block count, and breach of temperature ranges supported by the data storage device 106. For example, the scaling bar 502 indicates before connecting to power, a first time connecting to power, and a time since connecting to power.

At “1”, each of the plurality of indications 504 is light, such that the data storage device 106 has not been connected to power. At “2”, a first indication of the plurality of indications 504 is dark, indicating that the data storage device 106 has been connected to power for a first time. At “3”, a second indication and a third indication of the plurality of indications 504 are dark, indicating that the data storage device 106 has been connected to power for a period of time or may be based on one or more of a PEC count, an aggregation of a PEC count across one or more blocks, power on hours, bad block count, and breach of temperature ranges supported by the data storage device 106. The number of dark indications of the plurality of indications 504 may represent a severity of the one or more of a PEC count, an aggregation of a PEC count across one or more blocks, power on hours, bad block count, and breach of temperature ranges supported by the data storage device 106.

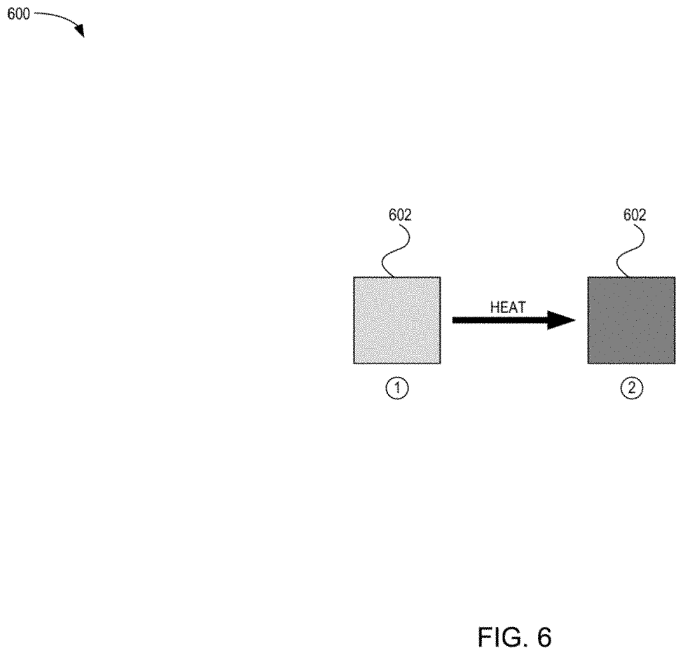

FIG. 6 is an exemplary illustration of an indicator 600 having a single indication 602, according to certain embodiments. The single indication 602 may be a thermochromic material. Thermochromic materials are color changing materials that change color due to a change in temperature, such as exceeding a threshold temperature for the material. Some thermochromic materials may change their color irreversibly. Examples of thermochromic materials may include poly [styrene-block-poly(methacrylic acid)] dissolved in tetrahydrofuran, copper(I) iodide, ammonium metavanadate, and/or combinations thereof. For example, poly [styrene-block-poly(methacrylic acid)] dissolved in tetrahydrofuran changes its color from green to orange irreversibly at a temperature range of between about 120° C. to about 130° C., copper(I) iodide is a solid pale tan material transforming at a temperature range of between about 60° C. to about 62° C. to an orange color, and ammonium metavanadate is a white material that turns to a brown color at about 150° C. and to black at about 170° C. It is contemplated that other thermochromic materials than those listed may be applicable to the described embodiments.

At “1”, the indicator 600 is shown as a first pattern to indicate that a data storage device, such as the data storage device 106 of FIG. 1, associated with the indicator 400 has not been connected to power. At “2”, the indicator 600 is shown as a second pattern to indicate that the data storage device 106 has been connected to power. The indicator 600 may be coupled to a heat source, such as a resistor or a heat sink. It is contemplated that the controller 108 may determine that a minimum period of time of usage has not yet elapsed and cause the heat source to not affect the indicator 600 (i.e., to not apply heat to the indicator 600). The heat sink may work in a passive manner by using heat generated by the data storage device to create an indication and the data storage device may actively heat the indicator using a heat source, such as the transistor, to create an indication.

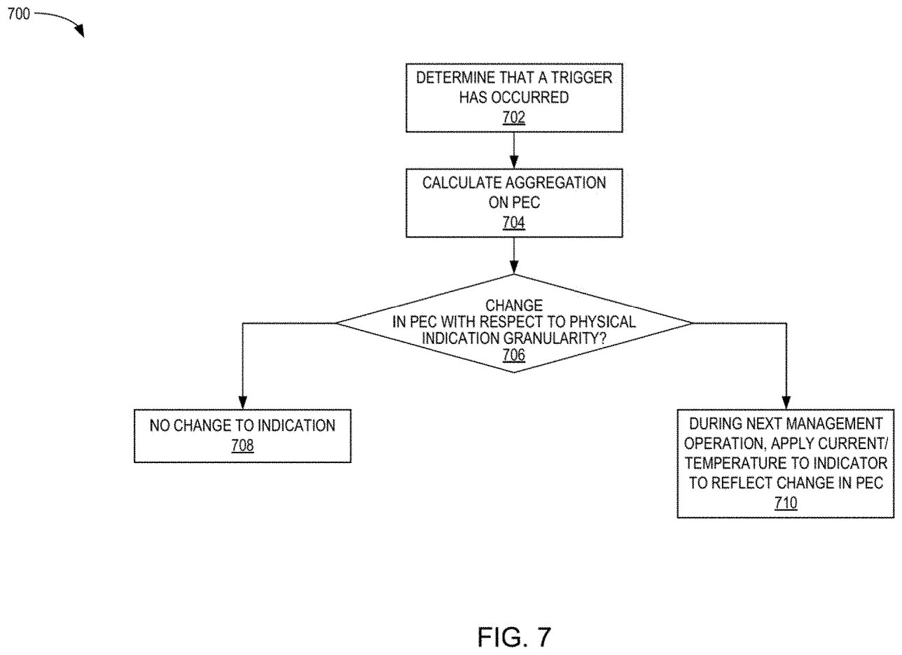

FIG. 7 is a flow diagram illustrating a method 700 of a data storage device, such as the data storage device 106 of FIG. 1, using an indicator, such as the indicator 150, 400, 500, 600 of FIGS. 1, 4, 5, and 6, as an indication of a health of the data storage device 106, according to certain embodiments. The health of the data storage device 106 may be related to a breach of warranty indication, a not new indication, an end of life indication, a life state indication, a hack alert indication, a malfunction indication, or a combination of the previously listed indications. Method 700 may be implemented by a controller, such as the controller 108 of FIG. 1. Furthermore, aspects of method 700 may be directed to a memory device, such as the NVM 110 of FIG. 1. Method 700 is an exemplary embodiment of an indication based on a PEC of the data storage device.

The breach of warranty indication may indicate that the data storage device 106 has exceeded a total bytes written capacity threshold, exceeded a working hours threshold, and/or was exposed to extreme temperature conditions over a threshold number of times. A single indication may be used for the breach of warranty indication.

The not new indication may indicate that the data storage device 106 has been used at least once. The not new indication may be configured and adjusted for other cases such as has not been written to and/or has not been read from, has not been connected to an external host, and/or has not been connected to a power source. A single indication may be used for the not new indication.

The end of life indication may indicate that the data storage device 106 has been used extensively and that a degradation in performance might be exhibited. Alternatively or additional, the end of life indication may indicate that the data storage device 106 is at risk of imminent failure. The indication may be triggered by an amount of overprovisioning blocks remaining in the data storage device 106, PEC statistics, BER statistics, power on hours, and the like. A single indication may be used for the end of life indication.

The life state indication may indicate an amount of cycles that the data storage device 106 has been used or a total bytes written of the data storage device 106. The controller 108 may cause one or more indications of a scaling bar, such as the scaling bar 502 of FIG. 5, to change from a first state to a second state based on the life state of the data storage device 106.

The hack alert indication may indicate that the data storage device 106 may have been under cyber-attack or hacked. A single indication may be used for the hack alert indication.

The malfunction indication may be based on signals of all the components on the board. The malfunction indication may indicate that one or more of the components is not functional or is only partially functional. In one example, single indication may be used for the malfunction indication. In another example, a scaling bar may be used for the malfunction indication, where the severity of the malfunction (e.g., harmless to catastrophic) is indicated by the number of indications changed to a second state on the scaling bar.

At block 702, the controller 108 determines that a trigger has occurred. It is to be understood that the trigger may be a flag that is based on one or more of the indications previously mentioned. In other examples, the flag may be the trigger or vice-versa. The trigger may be one or more of a PEC count, an aggregation of a PEC count across one or more blocks, power on hours, bad block count, and breach of temperature ranges supported by the data storage device 106. At block 704, the controller 108 calculates an aggregation on the PEC, where the aggregation may be calculated using a mean, a minimum, and/or a maximum PEC count of one or more memory devices of the NVM 110.

At block 706, the controller 108 determines if there is a change in the PEC with respect to a physical indication granularity. For example, the controller 108 may determine if the change in PEC is greater than some physical indication granularity. The physical granularity indication may be a pre-set value. For example, the pre-set value based on PEC count may be 100 PEC counts. If the change in PEC is not greater than some physical indication granularity at block 706, then controller 108 does not make a change to the indicator, such that the indicator remains in a first state or each indication of the indicator remains in a first state, at block 708. However, if the PEC change in PEC is greater than some physical indication granularity at block 706, then the controller 108 causes the indicator or one or more indications of the indicator to change from a first state to a second state to reflect the change in PEC at block 710. The change in the indication may be applied during a next management operation.

By including a physical indicator on the data storage device that indicates a health of the data storage device, where the physical indicator may operate in absence of an external power source, the reliability of a new data storage device provided to a customer may be ensured.

In one embodiment, a data storage device includes a housing and an indicator coupled to the housing. The indicator is configured to indicate a health and/or life stage of the data storage device and operate in the absence of an external power source.

The indicator is an electrophoretic display. The electrophoretic display comprises a single indication. The single indication has two states. A first state is associated with before connecting to power and a second state is associated with after connecting to power. The second state is a permanent state. The electrophoretic display is a scaling bar. One or more portions of the scaling bar changes over time. The scaling bar indicates before connecting to power, a first time connecting to power, and a time since connecting to power. The health of the data storage device is based on a program erase cycle (PEC), bad block count, and a number of breaches of a threshold temperature. The indicator comprises a thermochromic material. A color change of the thermochromic material is irreversible. The thermochromic material is selected from a group consisting of poly [styrene-block-poly(methacrylic acid)] dissolved in tetrahydrofuran, copper(I) iodide, ammonium metavanadate, or combinations thereof.

In another embodiment, a data storage device includes a housing, a controller disposed in the housing, and an indicator coupled to the housing and the controller. The controller is configured to calculate a health parameter of the data storage device, determine that that the health parameter has exceeded a threshold, and cause the indicator change from a first state to a second state.

The health parameter is based on one or more of a program erase count (PEC) of a memory device of the data storage device, a breach of warranty of the data storage device, a single use of the data storage device, an end of life of the data storage device, a life state of the data storage device, a hack alert, and a malfunction of one or more components of the data storage device. The indicator is capable of operating without an external power source. The controller is further configured to calculate an aggregation on a program erase count (PEC) of a memory device of the data storage device. The controller is further configured to determine if there is a change in the PEC with respect to a physical indication granularity. The controller is further configured to cause the indicator change from the first state to the second state during a next management operation.

In another embodiment, a data storage device includes means to indicate a use and/or a health of the data storage device absent of an external power source.

The means to indicate includes electrophoretic or thermochromic materials.

While the foregoing is directed to embodiments of the present disclosure, other and further embodiments of the disclosure may be devised without departing from the basic scope thereof, and the scope thereof is determined by the claims that follow.

1. A data storage device, comprising:
a housing; and
an indicator coupled to the housing, wherein the indicator is configured to:
indicate a health of the data storage device, wherein the health indicates one or more of:
a breach of warranty of the data storage device, wherein the breach of warranty indicates that a total number of bytes written threshold has been exceeded, a working hours threshold has been exceeded, and/or a number of exposures to extreme temperature conditions threshold has been exceeded;
a hack alert of the data storage device, wherein the hack alert indicates that the data storage device has been under cyber-attack or hacked; and
a malfunction of one or more components of the data storage device, wherein the malfunction of the one or more components indicates that the one or more components is not functional or is partially functional based on a received signal from the one or more components; and
operate in the absence of an external power source.

2. The data storage device of claim 1, wherein the indicator is an electrophoretic display.

3. The data storage device of claim 2, wherein the electrophoretic display comprises a single indication.

4. The data storage device of claim 3, wherein the single indication has two states, wherein a first state is associated with before connecting to power and a second state is associated with after connecting to power.

5. The data storage device of claim 4, wherein the second state is a permanent state.

6. The data storage device of claim 2, wherein the electrophoretic display is a scaling bar.

7. The data storage device of claim 6, wherein one or more portions of the scaling bar changes over time or changes based on a flag.

8. The data storage device of claim 6, wherein the scaling bar indicates before connecting to power, a first time connecting to power, and a time since connecting to power.

9. The data storage device of claim 1, wherein the health of the data storage device is based on a program erase cycle (PEC), bad block count, and a number of breaches of a threshold temperature.

10. The data storage device of claim 1, wherein the indicator comprises a thermochromic material.

11. The data storage device of claim 10, wherein a color change of the thermochromic material is irreversible.

12. The data storage device of claim 10, wherein the thermochromic material is selected from a group consisting of:
poly [styrene-block-poly(methacrylic acid)] dissolved in tetrahydrofuran;
copper(I) iodide;
ammonium metavanadate; or
combinations thereof.

13. A data storage device, comprising:
a housing;
a controller disposed in the housing; and
an indicator coupled to the housing and the controller, wherein the controller is configured to:
calculate a health parameter of the data storage device, wherein the health parameter indicates one or more of:
a breach of warranty of the data storage device, wherein the breach of warranty indicates that a total number of bytes written threshold has been exceeded, a working hours threshold has been exceeded, and/or a number of exposures to extreme temperature conditions threshold has been exceeded;
a hack alert of the data storage device, wherein the hack alert indicates that the data storage device has been under cyber-attack or hacked; and
a malfunction of one or more components of the data storage device, wherein the malfunction of the one or more components indicates that the one or more components is not functional or is partially functional based on a received signal from the one or more components;
determine that that the health parameter has exceeded a threshold; and
cause the indicator change from a first state to a second state.

14. (canceled)

15. The data storage device of claim 13, wherein the indicator is capable of operating without an external power source.

16. The data storage device of claim 13, wherein the controller is further configured to calculate an aggregation on a program erase count (PEC) of a memory device of the data storage device.

17. The data storage device of claim 16, wherein the controller is further configured to determine if there is a change in the PEC with respect to a physical indication granularity.

18. The data storage device of claim 17, wherein the controller is further configured to cause the indicator change from the first state to the second state during a next management operation.

19. A data storage device, comprising:
means to indicate a health of the data storage device absent of an external power source, wherein the health indicates one or more of:
a breach of warranty of the data storage device, wherein the breach of warranty indicates that a total number of bytes written threshold has been exceeded, a working hours threshold has been exceeded, and/or a number of exposures to extreme temperature conditions threshold has been exceeded;
a hack alert of the data storage device, wherein the hack alert indicates that the data storage device has been under cyber-attack or hacked; and
a malfunction of one or more components of the data storage device, wherein the malfunction of the one or more components indicates that the one or more components is not functional or is partially functional based on a received signal from the one or more components.

20. The data storage device of claim 19, wherein the means to indicate includes electrophoretic or thermochromic materials.
